(19) United States
(12) Patent Application Publication
(10) Pub. No.: US 2024/0384422 A1
(43) Pub. Date: Nov. 21, 2024

(54) Robust Low-cost Air Diffusion Cathodes for Water Treatment

(71) Applicant: The Regents of the University of California, Oakland, CA (US)

(72) Inventors: Ashok J. Gadgil, Berkeley, CA (US); Siva Rama Satyam Bandaru, Berkeley, CA (US)

(73) Assignee: The Regents of the University of California, Oakland, CA (US)

(21) Appl. No.: 18/665,537

(22) Filed: May 15, 2024

Related U.S. Application Data
(60) Provisional application No. 63/502,655, filed on May 16, 2023.

(51) Int. Cl. C25B 11/032; C02F 1/461; C02F 1/467; C25B 1/30; C25B 11/061; C25B 11/095

(52) U.S. Cl. CPC C25B 11/032; C02F 1/46109; C02F 1/4672; C25B 1/30; C25B 11/061; C25B 11/095; C02F 2001/46142; C02F 2001/46166

(57) ABSTRACT

A gas diffusion air-cathode is made with a non-reacting metal as the supporting conducting substrate, such as in the form of a stainless steel mesh.

### CROSS-REFERENCES TO RELATED APPLICATIONS

This application claims priority to U.S. Provisional Application No. 63/502,655, filed May 16, 2023, the disclosures of which are hereby incorporated by reference in its entirety for all purposes.

### INTRODUCTION

Gas diffusion electrodes are used in electrochemical applications to produce value added chemicals such as H2O2. Carbon paper and carbon cloth are used as substrates in gas diffusion cathodes. However, carbon based substrates are not mechanically sturdy as they can develop cracks under flexion. They are also expensive ($150 for a 310 micron thick carbon paper of 40 cm'40 cm).

### SUMMARY OF THE INVENTION

The invention provides air-cathodes made with a non-reacting metal (e.g. stainless steel) mesh as the supporting conducting substrate. The metal may be in the form of an alloy or coating, such as one metal on another, or a metal coating on a non-metal substrate.

The disclosed metal air cathodes avoid the use of carbon paper altogether, are more cost effective, flexible yet strong and durable, and provide robust gas-diffusion cathodes for sustained production of H2O2 over long-periods of operation. Hence, advantages include ease of construction, much lower cost of conducting substrate, and mechanical robustness of the final product (air-cathode) without sacrificing functionality.

The invention provides a practical replacement of carbon-substrate based air-cathode with the metal-mesh base air-cathode. Practical applications include removal of a toxic metalloid (e.g. arsenic), such as in Air-cathode Assisted Iron Electrocoagulation (ACAIE), and in-situ production of H2O2 from polluted water.

Embodiments and variations include use of a wire mesh made from metal or metal-alloys other than the exemplified stainless steel, so long as the other metals or alloys are non-reacting with the electrolyte and do not corrode in the indicated use.

The invention provides methods, compositions and systems, such electrolysis cells, comprising or deploying the disclosed cathodes.

In an aspect the invention provides a gas diffusion air-cathode made with a non-reacting (non-reacting with the electrolyte and do not corrode in the indicated use) metal as the supporting conducting substrate, such as in the form of a metal mesh, essentially as described herein.

In embodiments:
the metal is stainless steel, or other suitable metal that is non-reactive in the electrolyte, and stable, such as titanium, nickel, copper, etc.;
the metal is stainless steel in alloy of iron, resistant to rusting and corrosion, and containing at least at least 10.5% (mass fraction) Cr and maximum 1.2% (mass fraction) C, such as described in ISO 15510:2014;
the cathode is in the form of a metal mesh, or other forms that are gas-permeable, conducting, and mechanically supportive, such as a non-woven mat of metal fibers; and/or
the metal is in the form of an alloy or coating, such as one metal on another, and/or a metal on a non-metal.

In an aspect the invention provides an electrolysis cell comprising a gas diffusion air-cathode herein.

In an aspect the invention provides a method of electrolysis deploying a gas diffusion air-cathode herein.

In an aspect the invention provides a method of reducing metalloid content of a medium with a gas diffusion air-cathode herein.

In an aspect the invention provides a method of producing H2O2 with a gas diffusion air-cathode herein.

The invention encompasses all combinations of the particular embodiments recited herein, as if each combination had been laboriously recited.

### BRIEF DESCRIPTION OF THE DRAWINGS

FIGS. 1A-B: Digital images of the stainless steel air cathodes showing air facing side (A) and liquid facing side (B) of the cathode.

FIGS. 2A-B: H2O2 Faraday efficiency of the stainless steel air cathodes at various charge dosage rates (A) and current densities (B) at a constant charge dosage of 600 C/L.

FIGS. 3A-B. Two-layer cathode after about 16 hours of exposure to electrolyte solution after running the experiments. Air-facing surface (A), and water-facing surface (B). The cathode shows signs of discoloration on both sides.

FIGS. 4A-B. Four-layer cathode air-facing side (A), and liquid-facing side (B). No leaks are visible.

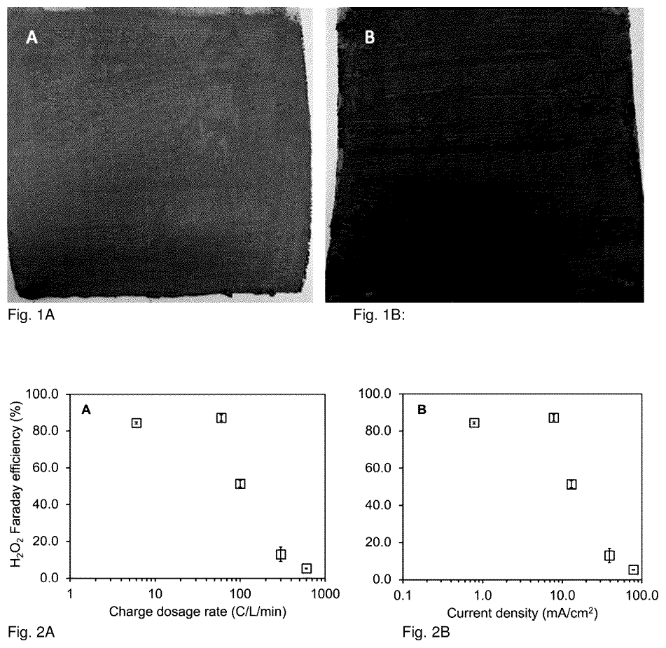

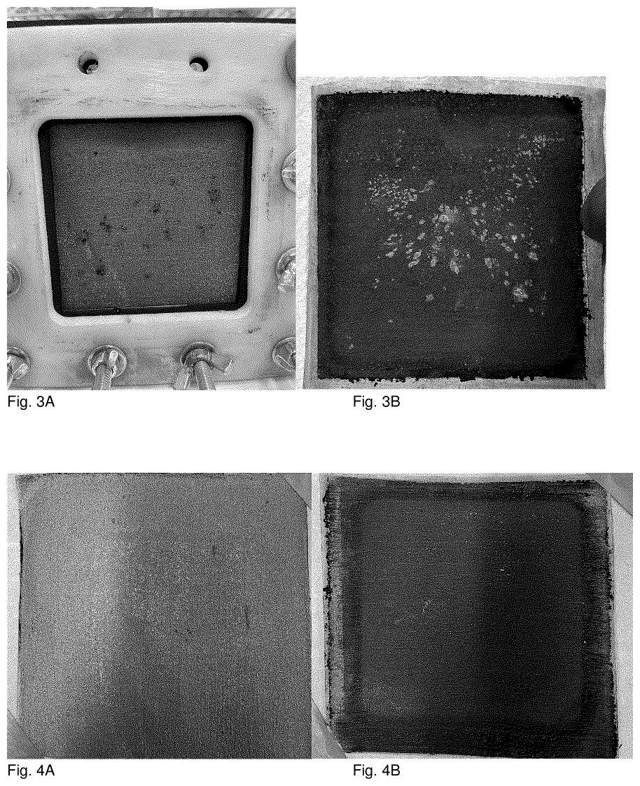

### DESCRIPTION OF PARTICULAR EMBODIMENTS OF THE INVENTION

Unless contraindicated or noted otherwise, in these descriptions and throughout this specification, the terms “a” and “an” mean one or more, the term “or” means and/or. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including citations therein, are hereby incorporated by reference in their entirety for all purposes.

We describe below how an embodiment of the metal-mesh air-cathode is fabricated, and then describe tests of its Faradaic efficiency in producing H2O2.

Fabrication: A stainless steel mesh (https://www.mcmaster.com/9319T185/) was used as substrate instead of carbon paper to fabricate air-diffusion cathode. The recipe of stainless steel air cathode fabrication generally followed the air-cathode fabrication described in Barazesh (2015) with one exception. In the SS air cathode, a hydrophobic layer (0.6 grams of graphite powder and 2 ml of 60 wt % PTFE suspension) was coated on either side of the stainless steel mesh (10 cm×10 cm). After the first coating of the hydrophobic layer on SS mesh, 20 minute air drying and sintering at 350 C for 40 minutes was conducted before the second coating on the opposite side. Catalyst layer consisting of carbon black, propanol and PTFE were coated on top of the hydrophobic layer.

H2O2 Faradaic efficiency experiments: These experiments were carried out in a two chamber electrochemical reactor separated by cation exchange membrane. Details of this configuration are shown in Bandaru et. al 2020, ES&T. An electrolyte consisting of 10 mM NaCl+10 mM Borate Buffer (pH 8.2)+100 mM Na₂SO₄ was used to determine the Faradaic efficiency of the stainless steel based gas diffusion cathodes. Volumes of catholyte and anolyte chambers are 0.5 L and 0.2 L respectively. Active surface of the air-cathode was 64 cm². Experiments carried out at charge dosage rates of 6 C/L/min (0.8 mA/cm2), 60 C/L/min (7.8 mA/cm2), 100 C/L/min (13.0 mA/cm2), 300 C/L/min (39.1 mA/cm2), and 600 C/L/min (78.1 mA/cm2) while keeping the charge dosage of 600 C/L constant. Experiments at 6 C/L/min, 100 C/L/min and 300 C/L/min are duplicated, whereas experiments at 60 C/L/min and 600 C/L/min were replicated four times. A spectrophotometric method (λ=405 nm) with titanium oxysulfate reagent was used to measure H2O2.

Results: The findings in FIG. 2 show that the H2O2 Faradaic efficiency was greater than 85% at current density densities <10 mA/cm2. At higher current densities (>10 mA/cm2), the H2O2 Faradaic efficiency decreased significantly. The formation of hydrogen gas bubbles on the cathode at higher current densities (>13 mA/cm2), may be responsible for the decrease in H2O2 Faradaic efficiency. At high current densities, water reduction to H2(g) may dominate over O2 reduction to H2O2 because of the favorable over-potentials for H2(g) generation. Increase in electroactive surface per unit area on the cathode, higher catalyst loading, and/or a better electrical contact between the conducting catalyst support and the catalyst itself, can decrease the overpotential and favor the kinetics of H2O2 generation over H2(g) evolution. Using these approaches, higher Faradaic efficiencies for H2O2 generation can also be achieved at current densities greater than 10 mA/cm2.

### Fabrication Processes

Various configurations of layers on the base-mesh were tested to refine the fabrication method, aiming to prevent leakages through the cathode and oxidation of the mesh, while having optimal performance.

For these configuration tests, we used the following materials: stainless steel mesh (sourced from McMaster https://www.mcmaster.com/9319T185), 60 wt % dispersion of Polytetrafluoroethylene (PTFE) in water, graphite powder, carbon black pearls, and propanol.

The process for fabricating the air-diffusion cathode generally followed the steps of Barazesh et al (2015). The quantities described below were for a 10 cm×10 cm stainless steel mesh specified above.

For the air-facing side of the cathode, multiple layers of the paste of graphite powder (6 grams) and PTFE solution (2 mL) were applied to the stainless steel mesh surface. Each layer was air-dried for 20 minutes then sintered in the oven at 350° C. for 40 minutes. This process was repeated after applying every layer of paste of graphite powder and PTFE.

For the water-facing (also called here “hydrophobic”) side, a single layer of graphite powder (6 grams) and PTFE solution (2 mL) was applied, following the same air-drying and sintering procedure as applied to the air-facing side. This was followed by a second layer using a mixture of carbon black pearls (150 mL), PTFE solution (83 μL), and propanol (2.917 mL) applied to the water-facing surface. After air-drying for 20 minutes, the cathode was sintered in an oven at 350° C. for 40 minutes.

### H2O2 Faradaic Efficiency Experiments

These experiments were conducted using a two-chamber electrochemical reactor, with the chambers separated by a cation-exchange membrane. An electrolyte solution (pH 8.2) of 12.5 mM NaCl+12.5 mM Borate Buffer+100 mM Na2SO4 was used to determine the

Faradaic efficiency of the air-cathode. The volume of the cathode and anode chamber are 0.5 L and 0.2 L respectively. The active surface area of the air cathode is 64 cm². In the experiments, we applied a fixed charge dose of 100 Coulombs/Liter (“C/L”) and a current density of 5 mA/cm2. The charge dosage rate and current density were held constant when testing the various configuration layers for the air cathodes, each obtained by slightly different fabrication methods. To measure the resulting concentration of H2O2, in the electrolyte in the cathode half-chamber (catholyte), a spectrophotometer with titanium oxysulfate reagent method was used.

### Results

Table 1 displays the performance of stainless steel mesh based air-cathodes fabricated using different numbers of layers. Testing at a constant charge dose of 100 C/L for two different fabricated samples of cathodes is then described. The experiments were run twice on the two-layer (air-facing side) cathode (A), which exhibited a H2O2 Faradaic efficiency on average of 65%. Tests were run thrice on the four-layer (air-facing side) cathode, which exhibited an average H2O2 Faradaic efficiency of 79%. Increasing the number of layers of graphite-and-PTFE on the air-side of cathodes reduces minor leakages.

TABLE 1
Cathode surface layers and observations after conducting 16 hours testing.

| Cathode | Air-facing side | Liquid-facing side | Observations |
|---|---|---|---|
| A | Two layers of | One layer (6 mg of graphite and 2 mL of | Discoloration of the cathodes' |
| | graphite(6 mg of | PTFE dispersion), a second layer of | water-facing side from the leak |
| | graphite and 2 mL | carbon black pearls (150 mL), PTFE | suggests corrosion of the SS mesh |
| | of PTFE) | dispersion (83 μL), and propanol (2.917 | |
| | | mL) | |
| B | Four layers (6 mg | One layer (6 mg of graphite and 2 mL of | No discoloration observed of the |
| | of graphite and | PTFE), a second layer of carbon black | water-facing side. |
| | 2 mL of PTFE) | pearls (150 mL), PTFE solution (83 μL), | |
| | | and propanol (2.917 mL) | |

### REFERENCES

1. Bazaresh et al (2015) Environ. Sci. Technol. 2015, 49, 12, 7391-7399
2. Bandaru et al (2020) Environ. Sci. Technol. 2020, 54, 10, 6094-6103
3. WO/2019/169398-ACAIE patent

1. A gas diffusion air-cathode comprising an electrolyte non-reacting, non-corroding metal configured as a mesh, as the supporting conducting substrate, configured to produce H2O2 with high Faradaic efficiency.

2. An air-cathode of claim 1, wherein the metal is stainless steel.

3. An air-cathode of claim 1, wherein the metal is stainless steel in alloy of iron containing at least at least 10.5% (mass fraction) Cr and maximum 1.2% (mass fraction) C, as described in ISO 15510:2014.

4. An air-cathode of claim 1, wherein the mesh comprises a non-woven mat of metal fibers or metal-coated fibers.

5. An air-cathode of claim 1, wherein the mesh comprises a nested cloth, woven mesh, woven cloth, foam, porous manifolds.

6. An air-cathode of claim 1, wherein the mesh comprises a 3D printed porous configuration.

7. An air-cathode of claim 1, wherein the metal is in the form of a coating, that is one metal on another, or metal coated on non-metal substrate.

8. An air-cathode of claim 1, wherein the air-cathode comprises an air-facing side wherein the surface of the mesh comprises multiple layers of graphite powder in a polytetrafluoroethylene (PTFE) solution, and a water-facing side wherein the surface of the mesh comprise a first layer of graphite powder in a PTFE solution, and a second layer of a mixture of carbon black pearls, PTFE solution, and propanol.

9. An air-cathode of claim 2, wherein the air-cathode comprises an air-facing side wherein the surface of the mesh comprises multiple layers of graphite powder in a polytetrafluoroethylene (PTFE) solution, and a water-facing side wherein the surface of the mesh comprise a first layer of graphite powder in a PTFE solution, and a second layer of a mixture of carbon black pearls, PTFE solution, and propanol.

10. An air-cathode of claim 3, wherein the air-cathode comprises an air-facing side wherein the surface of the mesh comprises multiple layers of graphite powder in a polytetrafluoroethylene (PTFE) solution, and a water-facing side wherein the surface of the mesh comprise a first layer of graphite powder in a PTFE solution, and a second layer of a mixture of carbon black pearls, PTFE solution, and propanol.

11. An air-cathode of claim 1, disposed in an electrolysis cell configured as a two-chamber electrochemical reactor, with the chambers separated by a cation-exchange membrane.

12. A method comprising electrolysis using a gas diffusion air-cathode of claim 1.

13. A method of reducing toxic metalloid content of a medium comprising electrolysis using a gas diffusion air-cathode of claim 1.

14. A method of producing H2O2 in water, for purification by advanced oxidation with hydroxyl radical (“OH*”), generated from H2O2 either with UV, or electrochemical activation of H2O2, using a gas diffusion air-cathode of claim 1.

15. A method comprising producing H2O2 with a gas diffusion air-cathode of claim 1.
